(19) United States
(12) Patent Application Publication
(10) Pub. No.: US 2021/0388664 A1
(43) Pub. Date: Dec. 16, 2021

(54) ADJUSTABLE DOOR FRAME FOR HVAC AIR HANDLER

(71) Applicant: ClimateCraft, Inc., Oklahoma CIty, OK (US)

(72) Inventors: Paul S. Little, Yukon, OK (US); Raymond Woods, Edmond, OK (US); Behzad Shahizare, Louisville, KY (US)

(21) Appl. No.: 17/323,158

(22) Filed: May 18, 2021

Related U.S. Application Data
(60) Provisional application No. 63/037,896, filed on Jun. 11, 2020.

(51) Int. Cl. E06B 3/26; E06B 3/70; E06B 1/52; E06B 7/23

(52) U.S. Cl. CPC E06B 3/26; E06B 3/7015; F24F 13/20; E06B 7/2303; E06B 7/231; E06B 1/526

(57) ABSTRACT

Methods and apparatus are disclosed for an adjustable door frame for an HVAC air handler. An example adjustable door frame for access to an HVAC air handler includes a hinge-side frame configured to couple to a hinge of a door for access to the HVAC air handler, a hingeless-side frame opposite the hinge-side frame, and one or more extensions configured to be positioned between the hinge-side frame and the hingeless-side frame to adjustably expand a depth of the door frame.

### CROSS REFERENCE TO RELATE APPLICATION

This application claims the benefit of U.S. Provisional Application No. 63/037,896, filed on Jun. 11, 2020, which is incorporated by reference herein in its entirety.

### TECHNICAL FIELD

The present disclosure generally relates to heating, venting, and air conditioning (HVAC) units and, more specifically, to an adjustable door frame for an HVAC air handler.

### BACKGROUND

HVAC air handling units (also referred to as HVAC air handlers) are devices used to regulate and circulate air. Typically, an HVAC air handling unit includes a cabinet, components housed within the cabinet, and air ducts (e.g., a return duct and a supply duct) extending from the cabinet. Example components housed within the cabinet of an HVAC air handling unit include a blower motor, heating and/or cooling element(s) (e.g., coils), and an air filter. Oftentimes, a larger HVAC air handling unit includes a door to provide service and maintenance workers with access to components of the HVAC air handling unit.

Doors and door frames for HVAC air handling units have different characteristics. For instance, a door of an HVAC air handling unit is either an inswing door or an outswing door. Further, a door has a thickness to fit that of a corresponding door frame, which may vary from model to model. As a result, those who service and maintain various HVAC air handling units may need to stock a large number of different types of doors and door frames for HVAC air handling units.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for an adjustable door frame for an HVAC air handler. An example disclosed adjustable door for access to an HVAC air handler includes a door panel and a door frame. The door frame includes a hinge-side frame, a hingeless-side frame, and a modular coupler configured to be positioned between and couple to the hinge-side frame and the hingeless-side frame. The example disclosed adjustable door also includes a hinge configured to couple the door panel to the door frame.

In some examples, the door panel and the door frame are expandable. In some examples, the door panel, the door frame, and the hinge are adjustable between an outswing orientation and an inswing orientation. Some such examples further include a handle configured to couple to the door panel in both the outswing orientation and the inswing orientation.

In some examples, the door panel includes a hinge-side shell, a hingeless-side shell configured to couple to the hinge-side shell to define a door cavity, and an insulation panel configured to be positioned within the door cavity. In some such examples, the hinge is configured to couple to the hinge-side shell and the hinge-side frame to hingedly couple the door panel to the door frame. In some such examples, the hingeless-side shell and the hinge-side shell are configured to adjustably set a depth of the door cavity. Some such examples further include a compression gasket configured to be positioned between the hingeless-side frame of the door frame and hingeless-side shell of the door panel. Some such examples further include a flipper gasket configured to be positioned between the hinge-side frame of the door frame and hinge-side shell of the door panel.

In some examples, the door frame includes one or more extensions configured to adjust a depth of the door. In some such examples, to set the door frame in an expanded position, the one or more extensions are configured to be positioned between and couple to the modular coupler and one of the hinge-side frame or the hingeless-side frame.

An example disclosed adjustable door frame for access to an HVAC air handler includes a hinge-side frame configured to couple to a hinge of a door for access to the HVAC air handler, a hingeless-side frame opposite the hinge-side frame, and one or more extensions configured to be positioned between the hinge-side frame and the hingeless-side frame to adjustably expand a depth of the door frame.

In some examples, the door panel is adjustable between an outswing orientation and an inswing orientation. In some examples, the hinge-side frame, the hingeless-side frame, and the one or more extensions at least partially form a top wall, a bottom wall, and opposing side walls of the door frame.

In some examples, the hinge-side frame includes a first arm configured to couple to a hinge and a second arm configured to partially define the depth of the door frame. In some such examples, the second arm of the hinge-side frame is configured to couple to a first extension of the one or more extensions.

In some examples, the hingeless-side frame includes a first arm and a second arm that is configured to partially define the depth of the door frame. In some such examples, the second arm of the hingeless-side frame is configured to couple to a first extension of the one or more extensions.

In some examples, the hinge-side frame, the hingeless-side frame, and each of the one or more extensions are modular to facilitate adjustment of the depth of the door frame. In some examples, each of the hinge-side frame and the hingeless-side frame is configured to couple to each of the one or more extensions via snap fit.

In some examples, the one or more extensions includes a first extension configured to expand the depth of the door frame by a first distance. In some such examples, the one or more extensions includes a second extension configured to couple to the first extension to further expand the depth of the door frame by a second distance. Further, in some such examples, the first distance equals the second distance.

In some examples, each of the one or more extensions includes a first end defining a socket and an opposing second end defining a plug. In some such examples, the socket is configured to couple to a plug of the hinge-side frame or the hingeless-side frame. Further, some such examples include a coupler defining a first socket and an opposing second socket. In such examples, each of the first socket and the second socket is configured to couple to the respective plugs of the hinge-side frame, the hingeless-side, and each of the one or more extensions. Moreover, in some such examples, to couple a first extension of the one or more extensions to the hinge-side frame or the hingeless-side frame, the first socket is configured to receive the plug of the hinge-side frame or the hingeless-side frame and the second socket is configured to receive the plug of the first extension. Moreover, in some such examples, to couple the hinge-side frame to the hingeless-side frame, the first socket is configured to receive the plug of the hinge-side frame and the second socket is configured to receive the plug of the hingeless-side frame. In such examples, the coupler enables the hinge-side frame to the hingeless-side frame without the one or more extensions to contract the depth of the door frame.

### BRIEF DESCRIPTION OF THE DRAWINGS

For a better understanding of the instant disclosure, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example door panel and an example door frame when configured to have an expanded depth and operate as an outswing door in accordance with the teachings herein.

FIG. 2 depicts a partial cutaway view of the door panel and the door frame as configured in FIG. 1.

FIG. 3 depicts a top cross-sectional view of the door panel and the door frame as configured in FIG. 1.

FIG. 4 depicts a partial top cross-sectional view of the door panel and the door frame as configured in FIG. 1.

FIG. 5 depicts an expanded top cross-sectional view of the door frame of FIG. 1.

FIG. 6 depicts an expanded top cross-sectional view of the door frame and a partial cross-sectional view of the door panel as configured in FIG. 1.

FIG. 7 depicts a partial top cross-sectional view of the door panel and the door frame of FIG. 1 when configured to have a contracted depth and operate as an outswing door.

FIG. 8 depicts a partial top cross-sectional view of the door panel and the door frame of FIG. 1 when configured to have a further expanded depth and operate as an outswing door.

FIG. 9 illustrates the door panel and the door frame of FIG. 1 when configured to have the expanded depth and operate as an inswing door.

FIG. 10 depicts a partial cutaway view of the door panel and the door frame as configured in FIG. 9.

FIG. 11 a top cross-sectional view of the door panel and the door frame as configured in FIG. 9.

FIG. 12 depicts a partial top cross-sectional view of the door panel and the door frame as configured in FIG. 9.

FIG. 13 depicts an expanded top cross-sectional view of the door frame and a partial cross-sectional view of the door panel as configured in FIG. 9.

FIG. 14 depicts a partial top cross-sectional view of the door panel and the door frame of FIG. 1 when configured to have the contracted depth and operate as an inswing door.

FIG. 15 depicts a partial top cross-sectional view of the door panel and the door frame of FIG. 1 when configured to have the further expanded depth and operate as an inswing door.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example door assemblies for HVAC air handlers disclosed herein include modular components that snap together in order to reduce the number of components needed to be stocked for servicing HVAC air handlers of different sizes and configurations. For example, an adjustable door frame assembly disclosed herein includes one or more extensions that are added or removed in order to extend or contract, respectively, the thickness of the door frame in order to accommodate door panels of different thicknesses. Further, components of example frame and panel assemblies disclosed herein are reversible such the door frame and door are capable of being selectively arranged to operate in an outswing configuration or an inswing configuration.

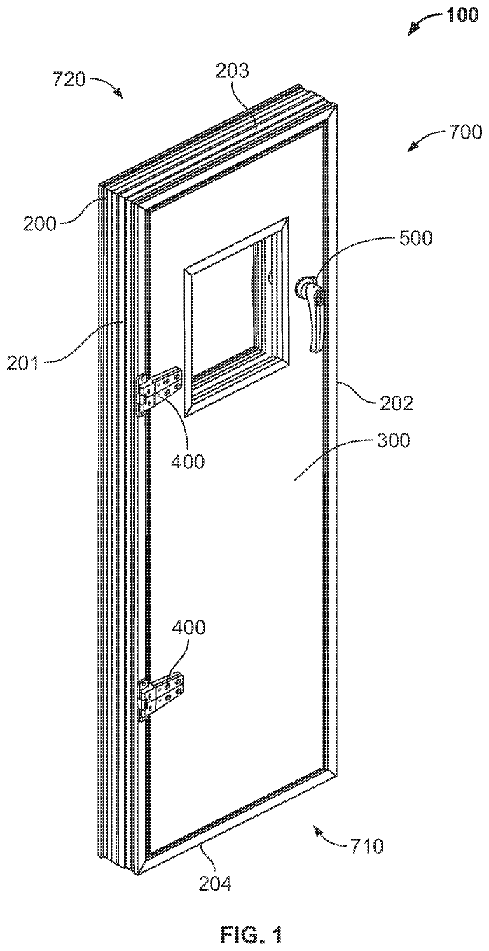

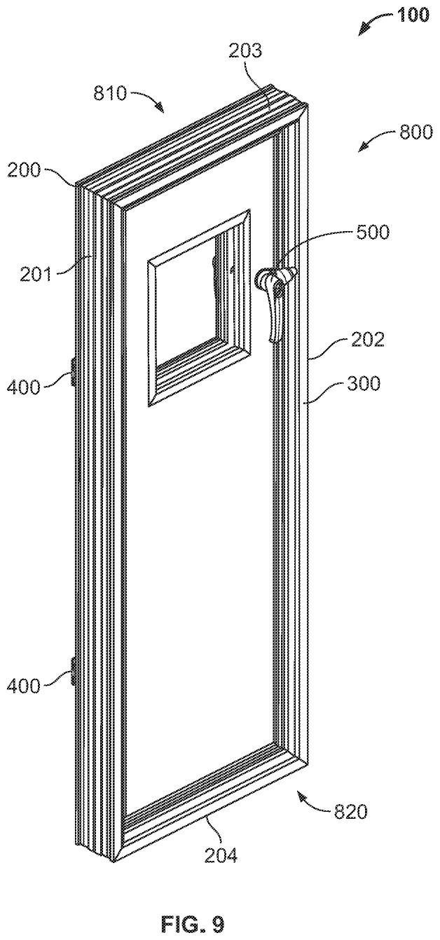

Turning to the figures, an example door assembly 100 is disclosed in accordance with the teachings herein. As shown in FIGS. 1 and 9, the door assembly 100 is configured to form a door frame 200 and a door panel 300. The door frame 200 includes a first side 201, a second side 202 opposite the first side 201, a top side 203, and a bottom side 204.

FIG. 1 illustrates the door assembly 100 when arranged to form an outswing door 700. In the illustrated example, the outswing door 700 is a left-hand outswing door with hinges 400 adjacent the first side 201 of the door frame 200 and a handle 500 adjacent the second side 202. As illustrated in FIG. 6, the hinges 400 are coupled to the door frame 200 via fasteners 410 and to the door panel 300 via fasteners 420. Returning to FIG. 1 and from the perspective of a hinge-side 710 of the outswing door 700, the first side 201 near which the hinges 400 are located is a left-hand side and the second side 202 near which the handle 500 is a right-hand side. From the perspective of a hingeless-side 720 of the outswing door 700, the first side 201 near which the hinges 400 are located is a right-hand side and the second side 202 near which the handle 500 is a left-hand side.

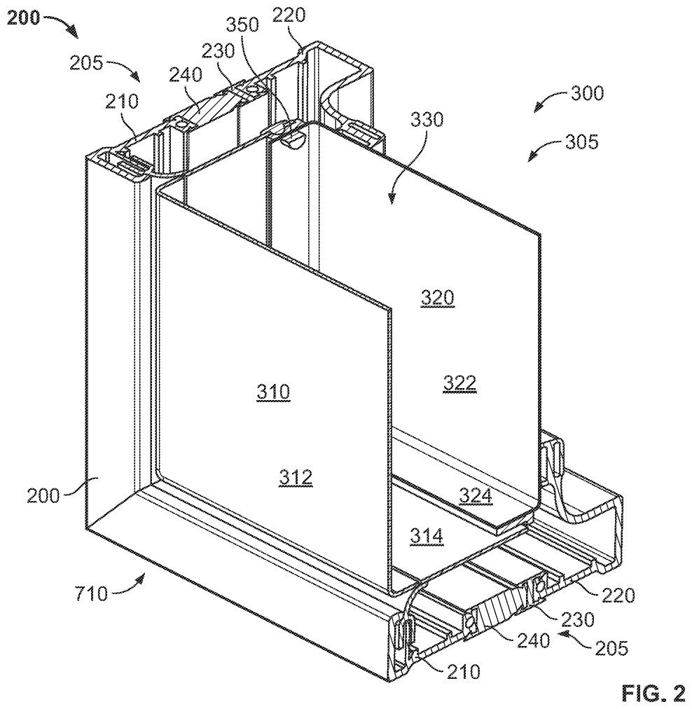

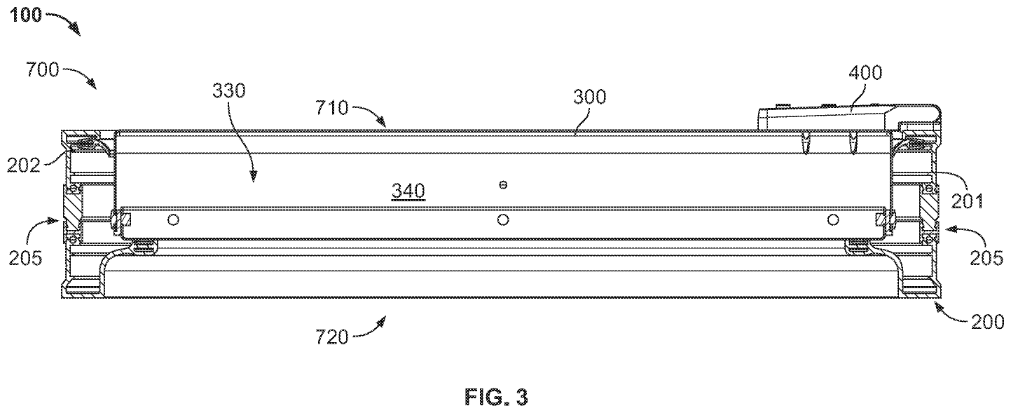

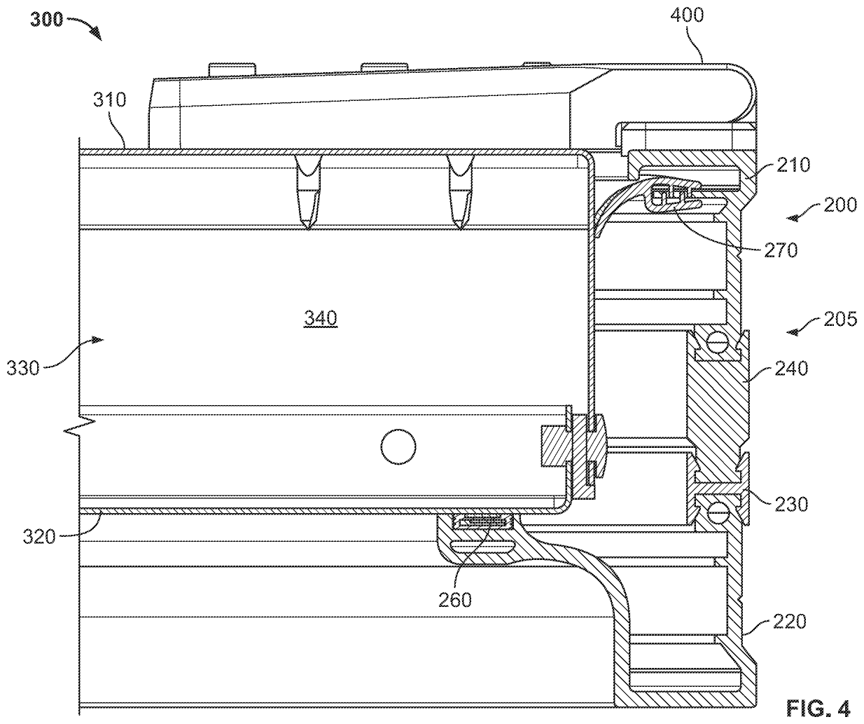

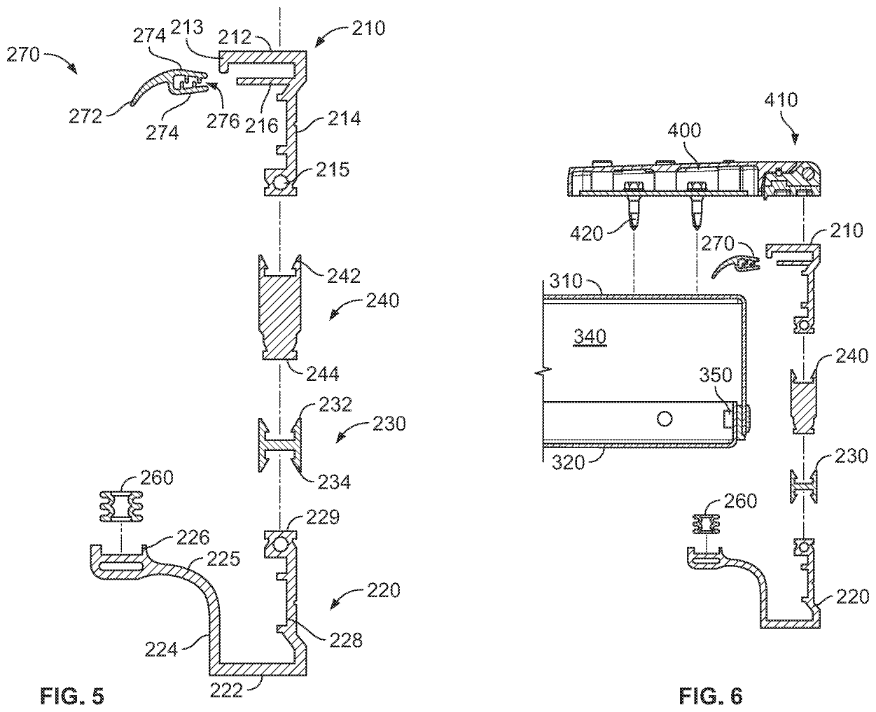

FIGS. 2-6 illustrate the frame assembly 205 and the panel assembly 305 when configured to have an expanded depth. More specifically, FIG. 2 depicts a partial cutaway view, FIG. 3 depicts a top cross-sectional view, and FIG. 4 depicts a partial top cross-sectional view of the frame assembly 205 and the panel assembly 305 when assembled to form the door frame 200 and the door panel 300. FIG. 5 depicts an expanded top cross-sectional view of the frame assembly 205, and FIG. 6 depicts a top cross-sectional view of the frame assembly 205 when unassembled and the panel assembly 305 when assembled.

The panel assembly 305 of the illustrated example includes a hinge-side shell 310, a hingeless-side shell 320, an insulation panel 340, and fasteners 350. The hinge-side shell 310 includes an outer wall 312 that defines an outer surface of the door panel 300 to which the hinges 400 is configured to couple. The hinge-side shell 310 also includes side walls 314 that extend perpendicularly from outer edges of the outer wall 312. The hingeless-side shell 320 includes an outer wall 322 defining an outer surface of the door panel 300 that is configured to be opposite the hinges 400. The hingeless-side shell 320 also includes side walls 324 that extend perpendicularly from outer edges of the outer wall 322. As illustrated in FIG. 2, the side walls 314 of the hinge-side shell 310 are configured to overlap with the side walls 324 of the hingeless-side shell 320 to define side walls of the door panel 300. Further, the fasteners 350 are configured to couple the side walls 314 of the hinge-side shell 310 to the side walls 324 of the hingeless-side shell 320.

When the hinge-side shell 310 and the hingeless-side shell 320 are coupled together via the fasteners 350, the hinge-side shell 310 and the hingeless-side shell 320 define a cavity 330 that is configured to house the insulation panel 340. The insulation panel 340 provides a built-in thermal break to the door panel 300 when positioned within the cavity 330. The hinge-side shell 310 and the hingeless-side shell 320 are sized and configured to securely and snugly house the insulation panel 340 in a close-fitting manner. For example, the expanded depth of the cavity 330 formed by the hinge-side shell 310 and the hingeless-side shell 320 is substantially similar to that of the insulation panel 340 (e.g., about 3 inches).

The frame assembly 205 is configured to enable the door panel 300 to securely couple to the door frame 200 via the hinges 400 when the door panel 300 is assembled to have the expanded depth. As illustrated in FIGS. 2-4, the frame assembly 205 includes a hinge-side frame 210, a hingeless-side frame 220, a coupler 230, an extension 240, a compression gasket 260, and a flipper gasket 270.

In FIGS. 2-4, the door frame 200 is formed by the hinge-side frame 210, the hingeless-side frame 220, the coupler 230, and the extension 240 that are coupled together. The hinge-side frame 210 is coupled to the extension 240, the extension 240 is positioned between and coupled to the hinge-side frame 210 and the coupler 230, the coupler 230 is positioned between and coupled to the extension 240 and the hingeless-side frame 220, and the hingeless-side frame 220 is coupled to coupler 230. In other examples, the position and/or orientation of the coupler 230 and the extension 240 may be adjusted in any manner that forms the door frame 200. For example, the coupler 230 and the extension 240 may be repositioned and/or reoriented such that the coupler 230 couples to the hinge-side frame 210 and the extension 240 couples to the hingeless-side frame 220.

Components of the frame assembly 205 are modular to enable the depth of the door frame 200 to be adjusted based on the depth of the door panel 300. For example, the hinge-side frame 210, the hingeless-side frame 220, the coupler 230, and the extension 240 include modular gendered and/or genderless connectors to enable the components of the frame assembly 205 to be rearranged, added, and/or removed in order to adjust the depth of the door frame 200. Further, each of the connectors are snap-fit connectors to enable the components of the frame assembly 205 to quickly and securely couple together.

In the illustrated example, each of the hinge-side frame 210, the hingeless-side frame 220, the coupler 230, and the extension 240 includes one or more modular male connector(s) (e.g., a plug) and/or female connector(s) (e.g., a socket) to enable the frame assembly 205 to be adjusted. For example, the hinge-side frame 210 includes a male connector 215, and the hingeless-side frame 220 includes a male connector 229. The extension 240 includes a female connector 242 on one end and a male connector 244 on an opposing end. Further, the coupler 230 of the illustrated example is an H-shaped coupler with opposing female connectors 232, 234. In FIGS. 2-4, the male connector 215 of the hinge-side frame 210 is coupled to the female connector 242 of the extension, the male connector 244 of the extension 240 is coupled to the female connector 232 of the coupler 230, and the female connector 234 of the coupler 230 is coupled to the male connector 229 of the hingeless-side frame 220.

In other examples, the components of the frame assembly 205 may include different gendered connectors than as is shown in FIGS. 2-7. For example, the hinge-side frame 210 or the hingeless-side frame 220 may include a female connection such that the extension 240 is capable of coupling directly to the hinge-side frame 210 and the hingeless-side frame 220 without the coupler 230.

FIG. 5 further depicts features of the components of the frame assembly 205. For example, the hinge-side frame 210 includes a first arm 212 that is configured to couple to the hinges 400 via fasteners 410. A flange 213 extends from a distal end of the first arm 212 to partially define the hinge side 720 of the door frame 200. The hinge-side frame 210 also includes a second arm 214. In the illustrated example, a distal end of the second arm 214 defines the male connector 215 of the hinge-side frame 210. A protrusion 216 also extends from the second arm 214. The protrusion 216 is configured to receive the flipper gasket 270 to sealingly couple the hinge-side frame 210 to the door panel 300.

The hingeless-side frame 220 of the illustrated example includes a base 222, a first arm 224 extending from an end of the base 222, and a second arm 228 extending from an opposing end of the base 222. The first arm 224 includes a curved portion 225 and an end portion 226 that extends from the curved portion 225. The end portion 226 is configured to receive the compression gasket 260 to sealingly couple the hingeless-side frame 220 to the door panel 300. The second arm 228 includes a distal end that defines the male connector 229 of the hingeless-side frame 220.

The flipper gasket 270 includes a flipper 272 and opposing arms 274. A slot is defined between the arms 274, and teeth 276 extend from the arms 274 into the slot. The flipper 272 is formed of flexible material to enable the flipper 272 to sealingly engage the side wall 314 of the hinge-side shell 310 of the door panel 300. Additionally, the teeth 276 are configured to grip the protrusion 216 of the hinge-side frame 210 when the protrusion 216 is at least partially positioned within the slot defined by the arms 274.

As illustrated in FIGS. 5-6, the compression gasket 260 and the flipper gasket 270 are configured to sealingly couple the door panel 300 to the door frame 200. For example, the compression gasket 260 is positioned between the end portion 226 of the hingeless-side frame 220 and the hingeless-side shell 320 to sealingly couple the hingeless-side frame 220 to the hingeless-side shell 320. The flipper gasket 270 is positioned between the hinge-side frame 210 and the hinge-side shell 310 to sealingly couple the hinge-side frame 210 to the hinge-side shell 310. For example, the teeth 276 of the flipper gasket 270 engage the protrusion 216 of the hinge-side frame 210 and the flipper 272 engages the side wall 314 of the hinge-side shell 310.

Further, the compression gasket 260 and the flipper gasket 270 are configured to compress and seal in the same manner when the door assembly 100 is arranged to form the inswing door 800 (FIGS. 9-15). That is, the compression gasket 260 and the flipper gasket 270 enable the frame assembly 205 and the panel assembly 305 to be selectively reversible between the outswing door 700 and the inswing door 800. Additionally, because the point of compression would be the same for the configuration of the outswing door 700 or the inswing door 800, the handle 500 is capable of being used for both the outswing door 700 and the inswing door 800.

In FIGS. 2-6, the frame assembly 205 includes the extension 240 to enable the door frame 200 have the extended depth. That is, the length of the extension 240 (e.g., 1 inch) causes the door frame 200 to have the extended depth (e.g., 3 inches). Because the components of the frame assembly 205 are modular, components of the frame assembly 205 are capable of being removed, added, and/or replaced in a manner that adjusts (e.g., contracts or extends) the depth of door frame 200. For example, to adjust the depth of the door frame 200, the extension 240 may (i) be removed, (ii) replaced with a differently-sized extension (e.g., a 2-inch extension), and/or combined with another extension.

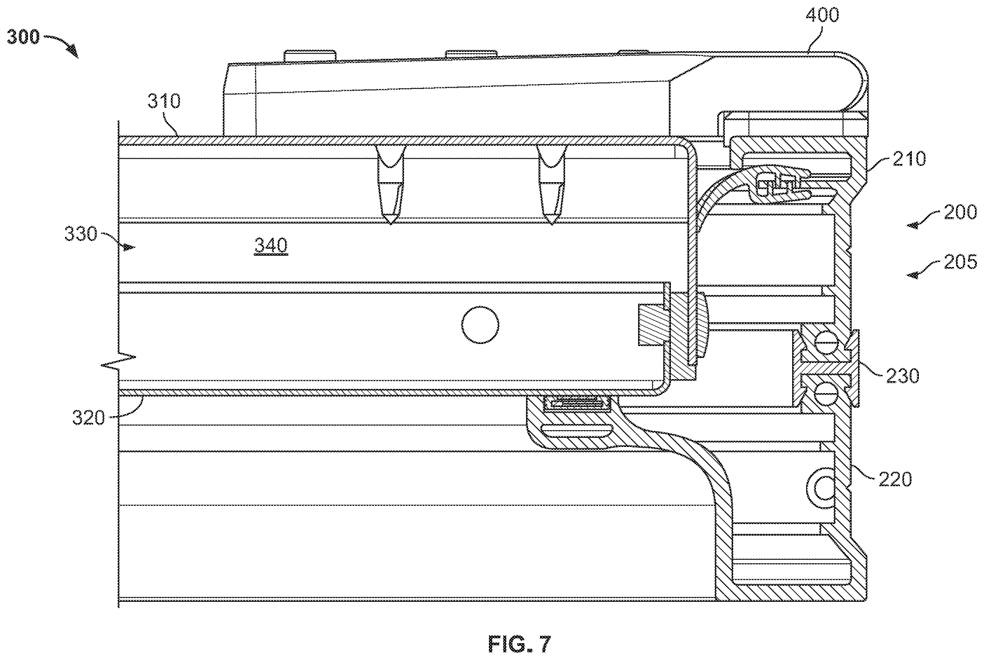

FIG. 7 is partial top cross-sectional view of the outswing door 700 when formed by the door assembly 100 to have a contracted depth. For example, the hinge-side shell 310 and the hingeless-side shell 320 of the panel assembly 305 are sized and arranged to securely house the insulation panel 340 having a relatively small thickness (e.g., 2 inches) in the cavity 330 of the door panel 300. The door frame 200 is formed by the hinge-side frame 210, the hingeless-side frame 220, and the coupler 230 without any extension of the frame assembly 205 to have a relatively small depth (e.g., 2 inches). The modularity of the components of the frame assembly 205 enables the coupler 230 to couple directly to the hinge-side frame 210 and the hingeless-side frame 220 to cause the door frame 200 to have the contracted depth.

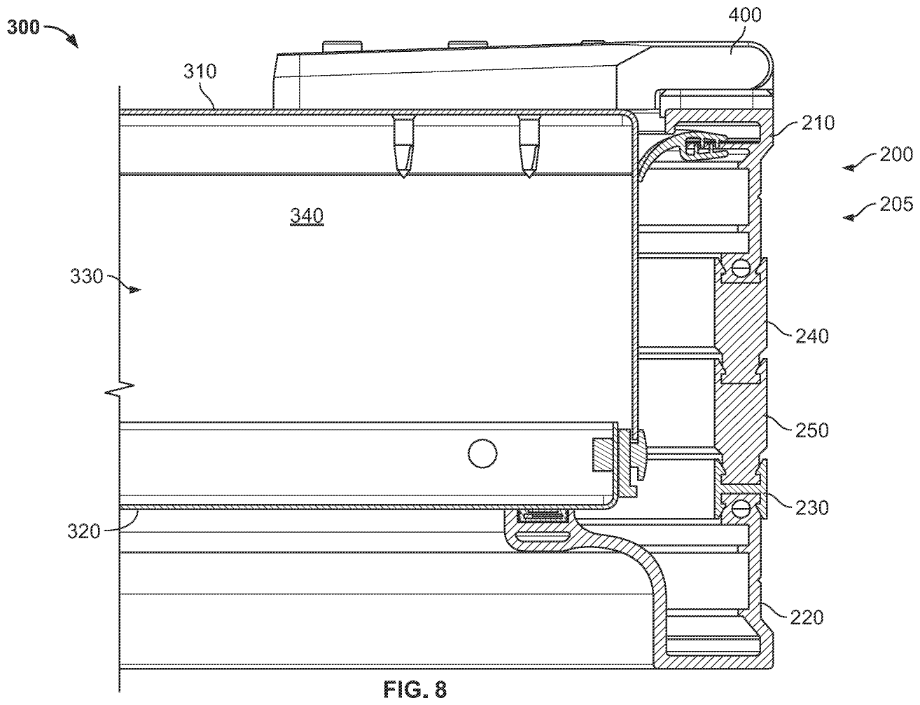

FIG. 8 is partial top cross-sectional view of the outswing door 700 when formed by the door assembly 100 to have a further extended depth. For example, the hinge-side shell 310 and the hingeless-side shell 320 of the panel assembly 305 are sized and arranged to securely house the insulation panel 340 having a relatively large thickness (e.g., 4 inches) in the cavity 330 of the door panel 300. The door frame 200 is formed by the hinge-side frame 210, the hingeless-side frame 220, the coupler 230, the extension 240, and another extension 250 of the frame assembly 205 to have a relatively large depth (e.g., 4 inches).

In the illustrated example, the door frame 200 is assembled by the hinge-side frame 210 coupling to the extension 240, the extension 240 coupling to the extension 250, the extension coupling 250 to the coupler 230, and the coupler 230 coupling to the hingeless-side frame 220. In other examples, the further extended depth of the door frame 200 is capable of being formed from a different arrangement of the frame assembly 205. For example, the extension 240 is capable of being coupled to the hingeless-side frame 220 and the coupler 230 is capable of being coupled to the hinge-side frame 210. Additionally, in the illustrated example, the length of the extension 250 (e.g., 1 inch) is substantially equal to that of the extension 240. In other examples, the length of the extension 250 may be different than that of the extension 240. For example, the extension 250 may be twice the length of the extension 240 such that the frame assembly 205 is capable of forming the further extended depth of the door frame 200 without utilizing the extension 240 in the assembly. Additionally, more or less of the modular extensions may be used to form different depths of the door frame 200.

Turning to FIG. 9, the door assembly 100 is arranged to form an inswing door 800. In the illustrated example, the inswing door 800 is a left-hand inswing door with the hinges 400 adjacent the first side 201 of the door frame 200 and the handle 500 adjacent the second side 202. From the perspective of a hinge-side 810 of the inswing door 800, the first side 201 near which the hinges 400 are located is a left-hand side and the second side 202 near which the handle 500 is a right-hand side. From the perspective of a hingeless-side 820 of the inswing door 800, the first side 201 near which the hinges 400 are located is a right-hand side and the second side 202 near which the handle 500 is a left-hand side.

The orientation of the frame assembly 205 and the panel assembly 305 is flipped or reversed in order form the inswing door 800 from the door assembly 100. That is, the components of the frame assembly 205 and the panel assembly 305 are reversible such that the door assembly 100 is configured to form the outswing door 700 when assembled in a first orientation and form the inswing door 800 when assembled in an opposing second orientation.

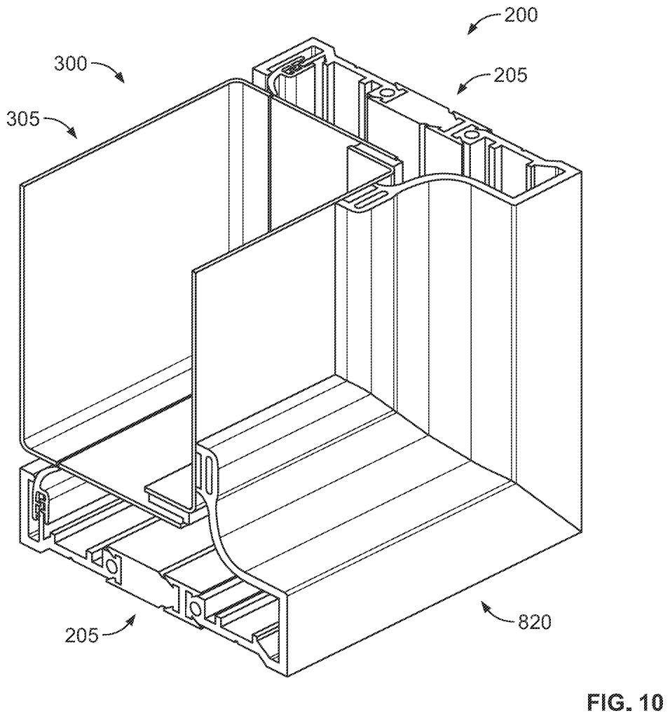

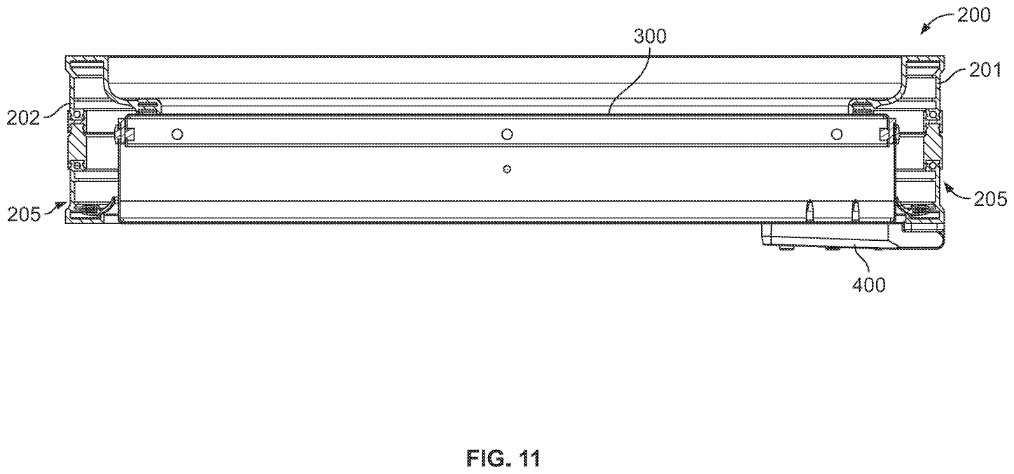

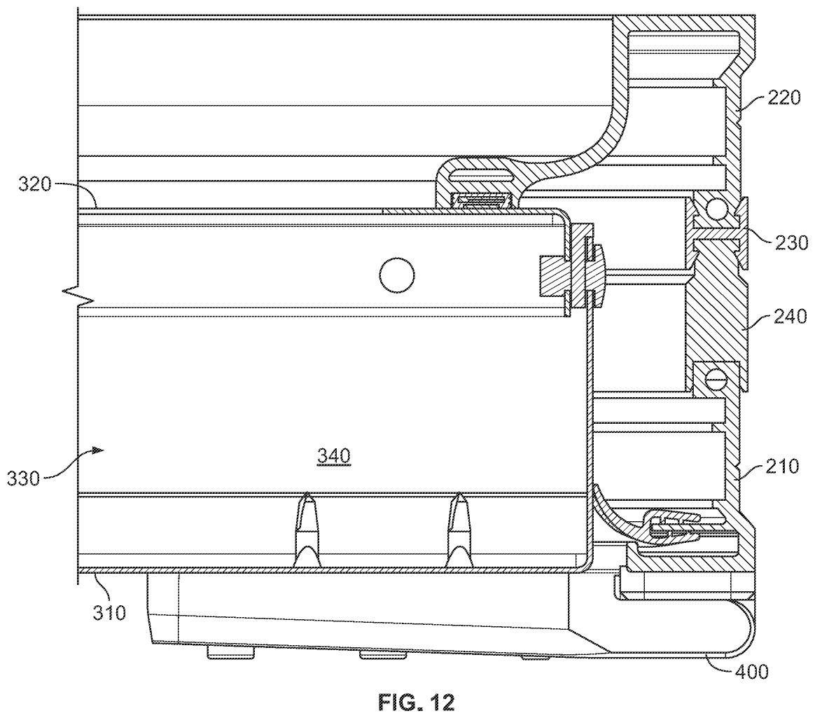

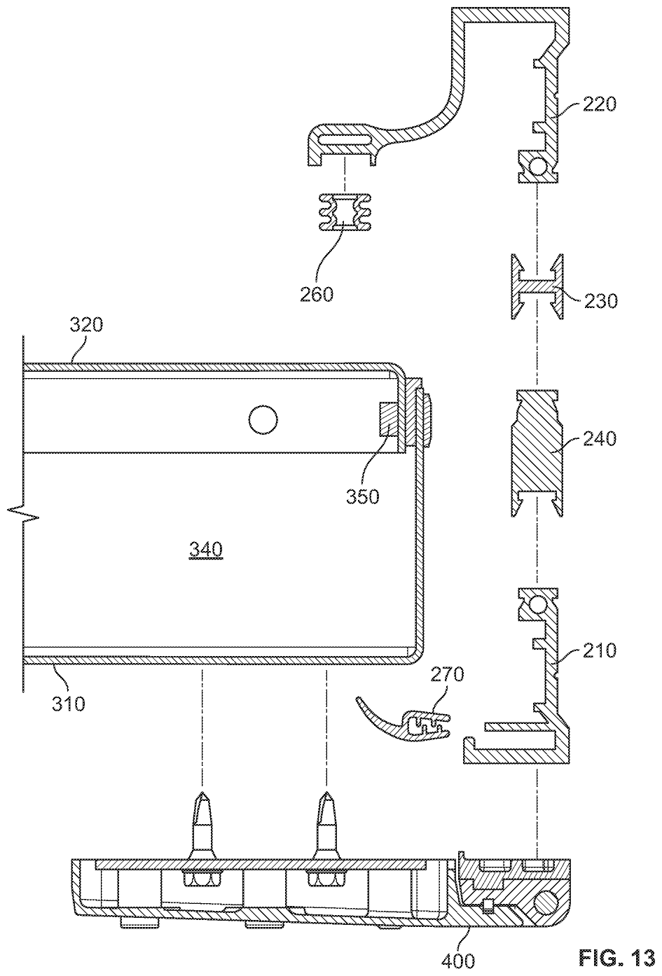

FIGS. 10-13 illustrate the frame assembly 205 and the panel assembly 305 when configured to form the inswing door 800 having an expanded depth (e.g., 3 inches). More specifically, FIG. 10 depicts a partial cutaway view, FIG. 11 depicts a top cross-sectional view, and FIG. 12 depicts a partial top cross-sectional view of the frame assembly 205 and the panel assembly 305 when assembled to form the inswing door 800 having the expanded depth. FIG. 13 depicts a top cross-sectional view of the frame assembly 205 when unassembled and the panel assembly 305 when assembled. As illustrated in FIGS. 10-13, the frame assembly 205 includes the hinge-side frame 210, the hingeless-side frame 220, the coupler 230, the extension 240, the compression gasket 260, and the flipper gasket 270. The panel assembly 305 includes the hinge-side shell 310, the hingeless-side shell 320, the insulation panel 340, and the fasteners 350.

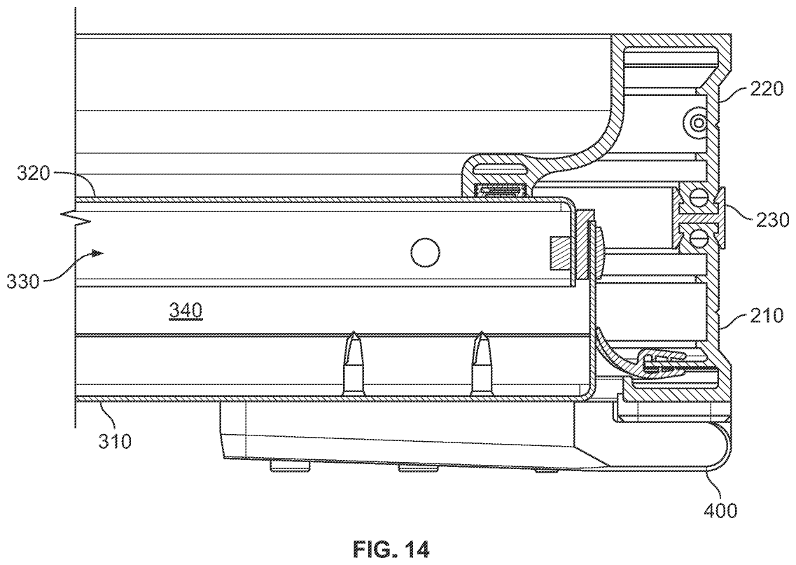

FIG. 14 is partial top cross-sectional view of the inswing door 800 when formed by the door assembly 100 to have a contracted depth. For example, the hinge-side shell 310 and the hingeless-side shell 320 of the panel assembly 305 are sized and arranged to house the insulation panel 340 having a relatively small thickness (e.g., 2 inches) in the cavity 330 of the door panel 300. The door frame 200 is formed by the hinge-side frame 210, the hingeless-side frame 220, and the coupler 230 without any extension of the frame assembly 205 to have a relatively small depth (e.g., 2 inches).

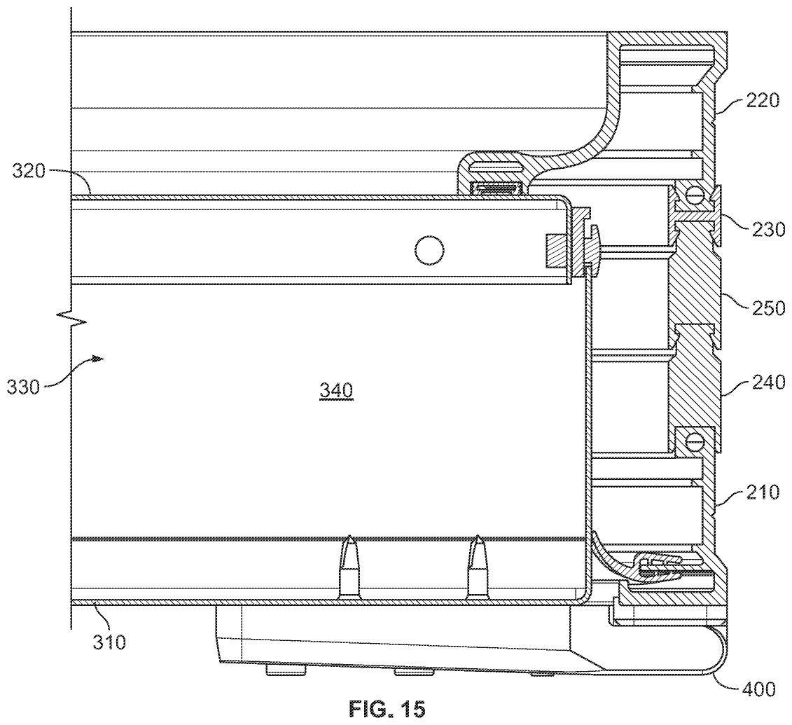

FIG. 15 is partial top cross-sectional view of the inswing door 800 when formed by the door assembly 100 to have a further extended depth. For example, the hinge-side shell 310 and the hingeless-side shell 320 of the panel assembly 305 are sized and arranged to house the insulation panel 340 having a relatively large thickness (e.g., 4 inches) in the cavity 330 of the door panel 300. The door frame 200 is formed by the hinge-side frame 210, the hingeless-side frame 220, the coupler 230, the extension 240, and the extension 250 of the frame assembly 205 to have a relatively large depth (e.g., 4 inches).

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. An adjustable door for access to an HVAC air handler, comprising:
a door panel;
a door frame comprising:
a hinge-side frame;
a hingeless-side frame; and
a modular coupler configured to be positioned between and couple to the hinge-side frame and the hingeless-side frame; and
a hinge configured to couple the door panel to the door frame.

2. The door of claim 1, wherein the door panel and the door frame are expandable.

3. The door of claim 1, wherein the door panel, the door frame, and the hinge are adjustable between an outswing orientation and an inswing orientation.

4. The door of claim 3, further comprising a handle configured to couple to the door panel in both the outswing orientation and the inswing orientation.

5. The door of claim 1, wherein the door panel comprises:
a hinge-side shell;
a hingeless-side shell configured to couple to the hinge-side shell to define a door cavity; and
an insulation panel configured to be positioned within the door cavity.

6. The door of claim 5, wherein the hinge is configured to couple to the hinge-side shell and the hinge-side frame to hingedly couple the door panel to the door frame.

7. The door of claim 5, wherein the hingeless-side shell and the hinge-side shell are configured to adjustably set a depth of the door cavity.

8. The door of claim 5, further comprising a compression gasket configured to be positioned between the hingeless-side frame of the door frame and hingeless-side shell of the door panel.

9. The door of claim 5, further comprising a flipper gasket configured to be positioned between the hinge-side frame of the door frame and hinge-side shell of the door panel.

10. The door of claim 1, wherein the door frame comprises one or more extensions configured to adjust a depth of the door.

11. The door of claim 10, wherein, to set the door frame in an expanded position, the one or more extensions are configured to be positioned between and couple to the modular coupler and one of the hinge-side frame or the hingeless-side frame.

12. An adjustable door frame for access to an HVAC air handler, comprising:
a hinge-side frame configured to couple to a hinge of a door for access to the HVAC air handler;
a hingeless-side frame opposite the hinge-side frame; and
one or more extensions configured to be positioned between the hinge-side frame and the hingeless-side frame to adjustably expand a depth of the door frame.

13. The door of claim 12, wherein the door panel is adjustable between an outswing orientation and an inswing orientation.

14. The door of claim 12, wherein the hinge-side frame, the hingeless-side frame, and the one or more extensions at least partially form a top wall, a bottom wall, and opposing side walls of the door frame.

15. The door of claim 12, wherein the hinge-side frame includes a first arm configured to couple to a hinge and a second arm configured to partially define the depth of the door frame.

16. The door of claim 15, wherein the second arm of the hinge-side frame is configured to couple to a first extension of the one or more extensions.

17. The door of claim 12, wherein the hingeless-side frame includes a first arm and a second arm that is configured to partially define the depth of the door frame.

18. The door of claim 17, wherein the second arm of the hingeless-side frame is configured to couple to a first extension of the one or more extensions.

19. The door of claim 12, wherein the hinge-side frame, the hingeless-side frame, and each of the one or more extensions are modular to facilitate adjustment of the depth of the door frame.

20. The door of claim 12, wherein each of the hinge-side frame and the hingeless-side frame is configured to couple to each of the one or more extensions via snap fit.

21. The door of claim 12, wherein the one or more extensions includes a first extension configured to expand the depth of the door frame by a first distance.

22. The door of claim 21, wherein the one or more extensions includes a second extension configured to couple to the first extension to further expand the depth of the door frame by a second distance.

23. The door of claim 22, wherein the first distance equals the second distance.

24. The door frame of claim 12, wherein each of the one or more extensions includes a first end defining a socket and an opposing second end defining a plug.

25. The door frame of claim 24, wherein the socket is configured to couple to a plug of the hinge-side frame or the hingeless-side frame.

26. The door of claim 25, further including a coupler defining a first socket and an opposing second socket, wherein each of the first socket and the second socket is configured to couple to the respective plugs of the hinge-side frame, the hingeless-side, and each of the one or more extensions.

27. The door of claim 26, wherein, to couple a first extension of the one or more extensions to the hinge-side frame or the hingeless-side frame, the first socket is configured to receive the plug of the hinge-side frame or the hingeless-side frame and the second socket is configured to receive the plug of the first extension.

28. The door of claim 26, wherein, to couple the hinge-side frame to the hingeless-side frame, the first socket is configured to receive the plug of the hinge-side frame and the second socket is configured to receive the plug of the hingeless-side frame, wherein the coupler enables the hinge-side frame to the hingeless-side frame without the one or more extensions to contract the depth of the door frame.
